(19) United States
(12) Patent Application Publication
(10) Pub. No.: US 2011/0225395 A1
(43) Pub. Date: Sep. 15, 2011

(54) DATA PROCESSING SYSTEM AND CONTROL METHOD THEREOF

(75) Inventor: Masayuki TSUJI, Yokohama (JP)

(73) Assignee: FUJITSU SEMICONDUCTOR LIMITED, Yokohama (JP)

(21) Appl. No.: 13/033,072

(22) Filed: Feb. 23, 2011

(30) Foreign Application Priority Data
Mar. 9, 2010 (JP) 2010-052232

(51) Int. Cl. G06F 9/312

(52) U.S. Cl. 712/205; 712/E09.033

(57) ABSTRACT

In a data processing system which includes a processor performing a processing in correspondence with a fetched instruction and a DRC capable of dynamically reconfiguring a circuit configuration in correspondence with configuration data, when the processor fetches the instruction, a configuration data decoder identifies whether or not the instruction is a configuration data instruction. When the instruction is the configuration data instruction, the configuration data is read from the configuration data memory in which the configuration data is housed and supplied to the DRC based on address information included in the configuration data instruction, thereby to enable the configuration data to be supplied to the DRC at a timing the same as a timing at which the instruction is fetched, so that the configuration data can be supplied at a high speed.

### CROSS-REFERENCE TO RELATED APPLICATION

This application is based upon and claims the benefit of priority of the prior Japanese Patent Application No. 2010-052232, filed on Mar. 9, 2010, the entire contents of which are incorporated herein by reference.

### FIELD

The embodiments discussed herein are directed to a data processing system having a processor and a circuit whose circuit configuration can be dynamically reconfigured, and to a control method thereof.

### BACKGROUND

A general-purpose processor has high programmability. On the other hand, since an instruction set in the general-purpose processor is versatile, techniques such as increasing an operation frequency or providing a mechanism to perform sophisticated instruction execution are often used in order to improve a processing performance of the processor simplex. However, as miniaturization of technologies proceeds, a problem in view of power consumption becomes obvious in the general-purpose processor, and for example, there is a limit in increasing the operational frequency for improvement of the processing performance. Further, in the market there exist numerous DSPs (Digital Signal Processors) which mount instructions suitable for specific application fields thereby to improve processing performances specialized in specific fields while maintaining versatility. In recent years, performance requirement of an application has been remarkably enhanced and deficiency of a processing performance has become obvious also in the DSP, a problem similar to that in the general-purpose processor being inevitable.

In order to solve the above-described problem, a field of configurable processor has been developed in which a user adds a unique instruction having been decided in a design stage thereby to customize a processor or a DSP. Thereby, it has become possible to efficiently improve a processing performance in a specific application. However, since a technique to customize the processor or the like by adding the unique instruction is highly specialized in the application, a specification of the instruction to be added is often limited to a specific program, so that programmability has been sacrificed. In addition, since customizing after manufacturing of a semiconductor device is impossible, it is difficult to forecast whether or not a requisition performance can be fulfilled in a case to cope with specification change or function addition in an application after manufacturing of a semiconductor device, and this point is a large risk factor.

As a circuit technology enabling customizing after manufacturing of a semiconductor device, there is a circuit (Dynamically Reconfigurable Circuit: hereinafter, also referred to as DRC) in which a circuit configuration can be dynamically reconfigured. By using the DRC, it is possible to decrease the above-described risk factor.

FIG. 10 is a block diagram illustrating a configuration example of a conventional data processing system which uses a DRC (for example, see Patent Document 1). In FIG. 10, a reference number 101 depicts a processor which operates based on an instruction set to which an instruction for controlling a function to be executed in a DRC 102 is added, while a reference number 102 depicts a DRC in which a circuit configuration can by dynamically reconfigured in correspondence with an instruction from the outside. The DRC 102 has a reconfigurable array 104 in which a circuit configuration can be reconfigured in correspondence with the instruction from the outside thereby to alter a data processing function, and a slave controller 103 controlling the reconfigurable array 104. The slave controller 103 executes supplying of data to the reconfigurable array 104, alteration of a circuit configuration of the reconfigurable array 104, and so on. A reference number 105 depicts an external memory, while a reference number 106 depicts an instruction cache temporarily storing the instruction supplied to the processor. A reference number 107 depicts a data cache which is connected to the processor 101, the DRC 102, and the external memory 105 and which temporarily stores data supplied from the external memory 105 to the processor 101 or to the DRC 102 or a result of computation by the processor 101 or by the DRC 102.

An example of a DRC execution sequence in the data processing system illustrated in FIG. 10 is illustrated in FIG. 11A. When a DRC instruction for controlling the function to be executed in the DRC 102 is supplied, the processor 101 executes the DRC instruction (S101) and indicates the slave controller 103 in the DRC 102 contents to be processed in the DRC 102, by a control signal (S102). The slave controller 103 reads configuration data to correspond to the contents from the external memory 105 (S103), and supplies the read configuration data to the reconfigurable array 104, thereby altering a circuit configuration of the reconfigurable array 104 (S104). The reconfigurable array 104 executes a processing (DRC computation) in the altered circuit configuration (S105), and after the processing terminates, notifies the slave controller 103 of termination (S106). The slave controller 103 receives a termination notification from the reconfigurable array 104, and interruptively notifies the processor of the termination (S107). FIG. 11B illustrates a relationship among timings of respective stages related to processing execution in the processor 101, the slave controller 103, and the reconfigurable array 104. In FIG. 11B, “F” denotes fetch process, “D” denotes decode process, “E” denotes execute process, “M” denotes memory access process, and “W” denotes write back process.

Further, in a data processing system using a DRC, there is suggested a technique to dynamically generate configuration data of the DRC by using an instruction of a processor (for example, Patent Document 2). In this technique, simultaneously with execution of the instruction by the processor, configuration data of the DRC and driver software to operate the DRC are auto-generated thereby to replace an original program in midstream. Further, there is suggested a technique to embed configuration data of a DRC in an instruction and enables the configuration data to be imported at a timing the same as that of the instruction (for example, Patent Document 3).
[Patent Document 1] Japanese Laid-open Patent Publication No. 11-307725
[Patent Document 2] International Publication Pamphlet No. WO 2004/025468
[Patent Document 3] International Publication pamphlet No. WO 01/016710

In order to use a DRC in which a circuit configuration can be dynamically reconfigured, configuration data of the DRC is separately necessary. Usually, the configuration data of the DRC is transferred from an external memory to the DRC as illustrated in FIG. 10 and FIG. 11B, and latency of computation is extended since an overhead for performing a direction thereof occurs as illustrated in FIG. 11B. Further, the same applies also to a technique to generate configuration data of a DRC from an instruction of a processor as described in Patent Document 2, since a usual instruction is required to be executed prior to generation of the configuration data. Such an overhead becomes an obstacle in mounting an additional instruction which is necessary to be processed at a high speed.

In order not to generate such an overhead, the technique described in Patent Document 3 can be used. However, since the configuration data of the DRC is embedded in the instruction, a size of an instruction code is wastefully consumed if the same configuration data exists in a plurality of places of the instruction code. Further, since the processor fetches an instruction different from an original instruction, in a system having an instruction cache it is easily predicted that the instruction cache is soiled thereby bringing about considerable decrease of a cache efficiency.

### SUMMARY

According to an aspect of the embodiment, there is provided a data processing system which includes: a first processing unit performing a processing in correspondence with a fetched instruction; a second processing unit capable of dynamically reconfiguring a circuit configuration in correspondence with configuration data; a configuration data memory in which the configuration data is housed; and a decoding unit identifying, when the first processing unit fetches the instruction, whether or not the instruction is a configuration data instruction. When the instruction is the configuration data instruction, the decoding unit reads the configuration data from the configuration data memory and supplies to the second processing unit, based on the address information included in the configuration data instruction.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram illustrating a configuration example of a data processing system in a first embodiment;

FIG. 2 is a diagram illustrating a configuration example of a reconfigurable array in the present embodiment;

FIG. 3 is a diagram illustrating a configuration example of a configuration data instruction, a configuration data memory, and a configuration data decoder in the present embodiment;

FIG. 4 is a diagram illustrating a configuration example of a configuration data decoder in the present embodiment;

FIG. 5 is a diagram illustrating a configuration example of a configuration data buffer in the present embodiment;

FIG. 6A and FIG. 6B are diagrams illustrating an example of a DRC execution sequence in a first embodiment;

FIG. 7A and FIG. 7B are diagrams illustrating another example of a DRC execution sequence in the first embodiment;

FIG. 8 is a diagram illustrating a configuration example of a data processing system in a second embodiment;

FIG. 9A and FIG. 9B are diagrams illustrating an example of a DRC execution sequence in the second embodiment;

FIG. 10 is a diagram illustrating a configuration example of a conventional data processing system; and

FIG. 11A and FIG. 11B are diagrams illustrating an example of a DRC execution sequence in the data processing system illustrated in FIG. 10.

### DESCRIPTION OF EMBODIMENTS

Hereinafter, embodiments are explained with reference to the drawings.

A data processing system of the embodiments uses a circuit (Dynamically Reconfiguralbe Circuit: DRC) in which a circuit configuration can be dynamically reconfigured and customizing is possible even after manufacturing of a semiconductor device, in order for a user to add his own instruction. In the present embodiments, a configuration data memory which is different from an external memory and which houses configuration data of the DRC is prepared inside, and address information (for example, a memory address) for reading the configuration data housed (stored) in the configuration data memory is embedded into an instruction as a field. This instruction is referred to as a configuration data instruction.

In the data processing system in the present embodiments, when the configuration data instruction is fetched by a processor or a DSP, along therewith, the configuration data is read from the configuration data memory by using the address information in the configuration data instruction and supplied to the DRC. In this way, increase of a memory capacity necessary for storage of the instruction is suppressed and an overhead related to the supply of configuration data of the DRC is prevented from occurring.

### First Embodiment

A first embodiment is explained.

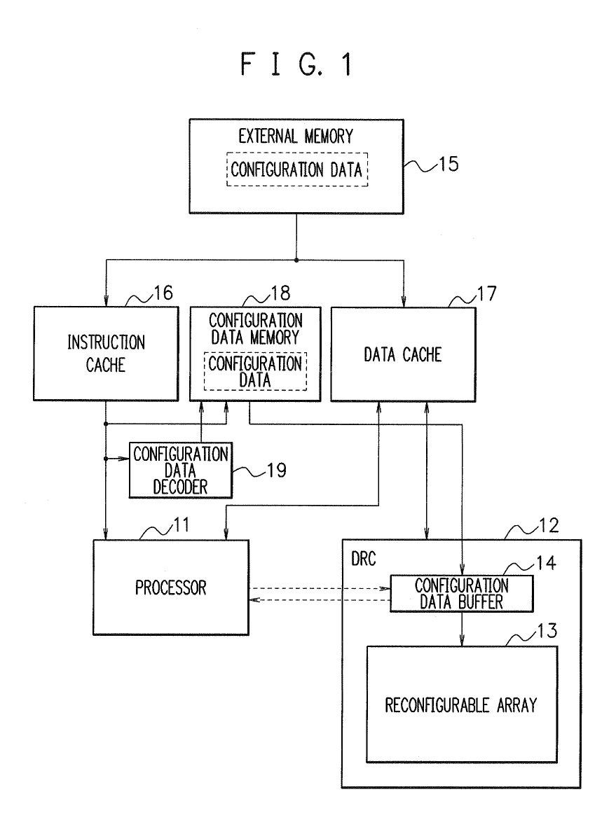

FIG. 1 is a block diagram illustrating a configuration example of a data processing system in the first embodiment. In FIG. 1, a reference number 11 depicts a processor operating based on an instruction set to which is added a configuration data instruction where address information (for example, a memory address) for reading configuration data of a DRC 12 from a configuration data memory 18 is embedded as a field. It is noted that in FIG. 1, the processor 11 is presented, but the processor is not limited thereto and can be a DSP (Digital Signal Processor).

A reference number 12 depicts a DRC in which a circuit configuration can be dynamically reconfigured in correspondence with supplied configuration data. The DRC 12 has a reconfigurable array 13 and a configuration data buffer 14. The configuration data buffer 14 is a buffer storing the configuration data of the DRC 12 read from the configuration data memory 18.

The reconfigurable array 13 has a plurality of registers and a multifunctional block having arbitrary functions, and the circuit configuration can be reconfigured in correspondence with the configuration data supplied via the configuration data buffer 14 thereby to alter a data processing function. The reconfigurable array 13, in which for example the circuit configuration inside the reconfigurable array 13 is altered as a result that the function of the multifunctional block and a connection between the multifunctional block and the register are altered in correspondence with the configuration data, provides a desired data processing function in correspondence with the configuration data.

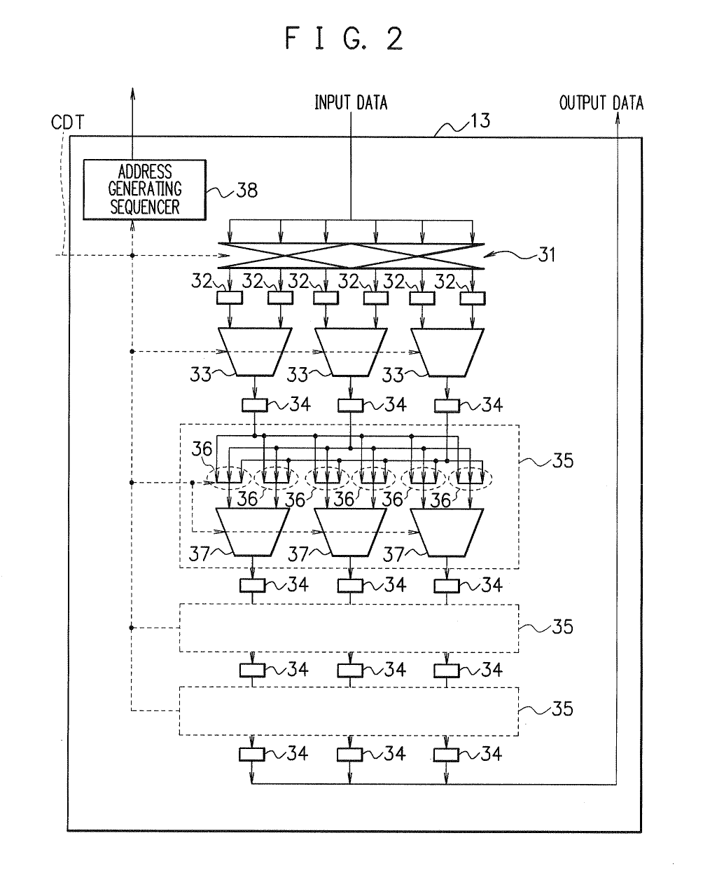

FIG. 2 illustrates a configuration example of the reconfigurable array 13 in the present embodiment. In FIG. 2, a reference number 31 depicts a barrel shifter (multifunctional block), a reference number 33 depicts an arithmetic unit (multifunctional block), a reference number 32 and a reference number 34 depict a register, a reference number 35 depicts a processing unit, and a reference number 38 depicts an address generating sequencer.

The barrel shifter (multifunctional block) 31, in which a circuit configuration is altered in correspondence with the configuration data CDT, outputs input data from the outside which is inputted to the reconfigurable array 13 to the register 32. The register 32 holds the data outputted from the barrel shifter (multifunctional block) 31.

In the arithmetic unit (multifunctional block) 33, a circuit configuration is altered in correspondence with the configuration data CDT. For example, the arithmetic unit (multifunctional block) 33 realizes functions such as an adder, a multiplier, a shifter (shift circuit) and the like in correspondence with the configuration data CDT. The arithmetic unit (multifunctional block) 33 uses the data stored in the register 32, executes a data processing in the altered circuit configuration, and outputs a processed result (data) to the register 34.

Each of the processing units 35 has a selector 36 and an arithmetic unit (multifunctional block) 37. Circuit configurations of the selector 36 and the arithmetic unit (multifunctional block) 37 in the processing unit 35 can be altered in correspondence with the configuration data CDT. For example, each arithmetic unit (multifunctional block) 37 realizes functions such as an adder, a multiplier, a shifter (shift circuit) and the like in correspondence with the configuration data CDT.

Each arithmetic unit (multifunctional block) 37 is connected to the register 34 provided in a previous stage of the processing unit 35 via respective corresponding selectors 36, in order that the data held in the register 34 is able to be inputted. Each arithmetic unit (multifunctional block) 37, using the inputted data, executes a data processing in the altered circuit configuration and outputs a processed result (data) to the register 34 provided in a subsequent stage of the processing unit 35.

Each of the registers 34 holds the data outputted from the corresponding arithmetic units (multifunctional blocks) 33, 37. The address generating sequencer 38 generates a memory address for reading input data used for a data processing from an external memory 15 or the like, and a memory address for writing output data being a processed result into the external memory 15 or the like, based on the configuration data CDT.

Here, as the configuration data CDT, information related to memory transfer of data, information related to function control of the multifunctional block in the reconfigurable array 13, and information related to a connection between the multifunctional blocks or between the multifunctional block and the register, and so on are able to be designated. In correspondence with the various information designated as the configuration data CDT, the function of the multifunctional block and the connection between the multifunctional blocks or between the multifunctional block and the register are controlled, and the reconfigurable array 13 performs a desired data processing.

The information related to memory transfer of data includes, for example, procedures of reading data into the reconfigurable array 13 and writing a processing result into the external memory 15, and the memory address. Further, information related to the connection between the multifunctional blocks or between the multifunctional block and the register includes circuit information related to the barrel shifter 31 and information related to control of the selector 36 in the processing unit 35.

It is noted that though FIG. 2 illustrates the reconfigurable array 13 as an example in which six registers 32 are disposed in parallel and three arithmetic units (multifunctional blocks) 33, 37 and three registers 34 are disposed in parallel per each processing stage, the reconfigurable array 13 is not limited thereto. The numbers of the arithmetic units (multifunctional block) 33, 37 and the register 34 which are disposed per each processing stage are optional, and it suffices if the register 32, the selector 36 and the like are provided in accordance therewith. Further, though the example in which three processing units 35 are serially connected is illustrated in FIG. 2, the number of the processing units 35 is also optional. Further, it is also possible to configure that the output data is outputted to the outside not limitedly from the register 34 receiving the output of the processing unit 35 in a final stage, but from the register 34 receiving the output of other processing units 35 (processing units 35 in a mid-stage, not in the final stage).

Back to FIG. 1, a reference number 15 denotes an external memory in which an instruction (program) to be supplied to the processor 11, configuration data of the DRC 12, and so on are stored. A reference number 16 denotes an instruction cache temporarily storing the instruction supplied to the processor 11. A reference number 17 denotes a data cache which is connected to the processor 11, the DRC 12, and the external memory 15 and which temporarily stores data supplied from the external memory 15 to the processor 11 or the DRC 12 and a result of computation by the processor 11 or the DRC 12.

A reference number 18 denotes the configuration data memory housing the configuration data of the DRC 12. At a time of starting up (boot sequence or the like) of the data processing system, the configuration data of the DRC 12 stored in the external memory 15 is copied and stored in the configuration data memory 18. It is noted that it suffices if copying of the configuration data of the DRC 12 stored in the external memory 15 into the configuration memory 18 is done before start of a data processing operation in the data processing system.

A reference number 19 depicts a configuration data decoder decoding an instruction simultaneously with instruction fetching by the processor 11. If the instruction is a configuration data instruction in which a memory address for reading the configuration data of the DRC 12 is embedded, the configuration data decoder 19 performs a read request (output request) to the configuration data memory 18 and makes the configuration data outputted from the configuration data memory 18.

FIG. 3 is a diagram illustrating a configuration example of the configuration data instruction, the configuration data memory 18, and the configuration data decoder 19 in the present embodiment. In FIG. 3, the same reference number is given to a component having the same function as that of a component illustrated in FIG. 1 and redundant explanation is omitted.

As described above, in the configuration data memory 18, the configuration data of the DRC 12 stored in the memory 15 is copied and housed. Further, the configuration data instruction CDI for reading the configuration data CFD from the configuration data memory 18 has an operation code OPC indicating being a configuration data instruction, and has a memory address MAD in which the configuration data is housed as a field.

When receiving an instruction fetch address IFA from the processor 11, the instruction cache 16 supplies an instruction stored in a region corresponding to the instruction fetch address IFA to the processor 11. The instruction RDI supplied to the processor 11 is also supplied to the configuration data memory 18 and the configuration data decoder 19. To the configuration data memory 18, there is supplied at least a portion equivalent to a field where the memory address MAD is housed in a case that the instruction is the configuration data instruction CDI, in the instruction RDI. Further, to the configuration data decoder 19, there is supplied at least an operation code portion in the instruction RDI. In other words, it suffices if what is supplied from the instruction cache 16 to the configuration data memory 18 includes the filed in which the memory address MAD can be housed and if what is supplied from the instruction cache 16 to the configuration data decoder 19 includes the operation code OPC.

The configuration data decoder 19 decodes the operation code OPC of the fetched instruction simultaneously with instruction fetching by the processor 11, and identifies whether or not the instruction is the configuration data instruction CDI. If the configuration data decoder 19 recognizes that the instruction is the configuration data instruction CDI, the configuration data decoder 19 outputs a read enable signal REN to the configuration data memory 18 and performs a read request (output request). Further, as an address signal of the configuration data memory 18, the field indicating the memory address MAD in the configuration data instruction CDI is connected simultaneously with instruction fetching.

Thereby, when the configuration data instruction CDI is fetched, the configuration data addressed by the memory address MAD of the configuration data instruction CDI is read from the configuration data memory 18 and outputted as read data RDT. The configuration data of the DRC 12 outputted as the read data RDT is supplied to the configuration data buffer 14 of the DRC 12 and housed therein. By doing as above, it is possible to read the configuration data from the configuration data memory 18 and to supply the configuration data to the DRC 12 at a high speed, at the same timing as that of instruction fetching by the processor 11. Further, for the instruction, since it is enough only to designate the memory address where configuration data is housed, the same configuration data does not exists in a plurality of places in the instruction and thus increase of a memory capacity necessary for storage of an instruction (program) can be suppressed.

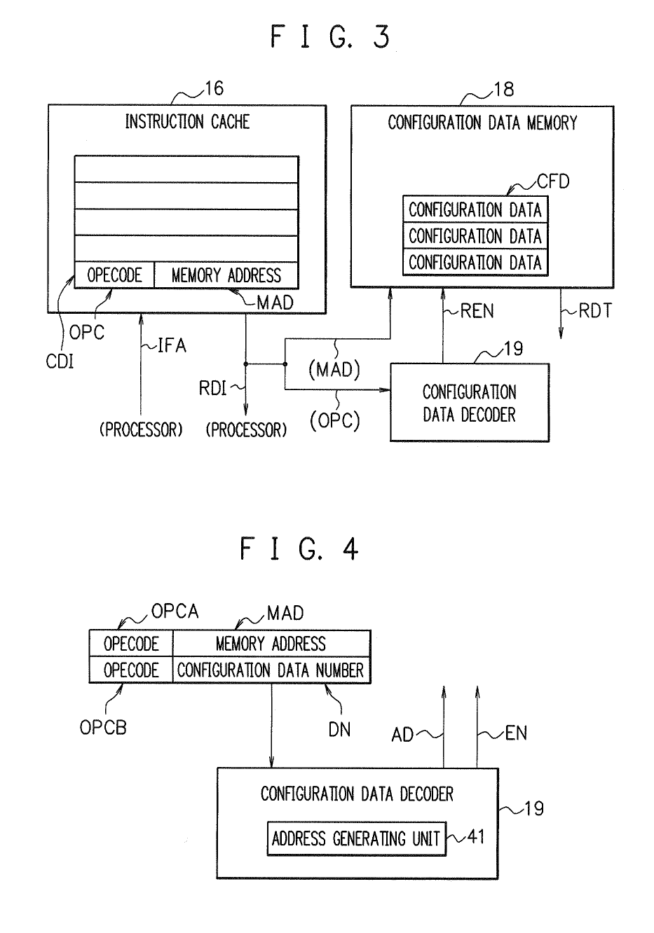

It is be noted that if the configuration data CFD of the DRC 12 is housed in a plurality of memory addresses in the configuration data memory 18, a plurality of configuration data instructions CDI indicating the respective memory addresses is used. However, the above-described configuration is only an example, and the configuration is not limited thereto. For example, instead of using the plural configuration data instructions CDI, as illustrated in FIG. 4 there is prepared a configuration data instruction indicating a first address of a region where the configuration data is housed and a memory amount (configuration data number or data amount) to be consumed. Then, the configuration data decoder 19 may generate an address based on the first address of the region in which the configuration data is housed and the memory amount (configuration data number or data amount) to be consumed.

FIG. 4 is a diagram illustrating another configuration example of the configuration data decoder 19 in the present embodiment. As illustrated in FIG. 4, the configuration data decoder 19 has an address generating unit 41. One of the configuration data instructions has an operation code OPCA indicating being the configuration data instruction and indicating having a first memory address MAD of the region in which the configuration data of the DRC 12 is housed as a field. Further, another of the configuration data instructions has an operation code OPCB indicating being the configuration data instruction and indicating having a memory amount (configuration data number or data amount) DN the configuration data of the DRC 12 consumes as a field.

The configuration data decoder 19 decodes the operation code of the fetched instruction simultaneously with instruction fetching by the processor 11, and identifies whether or not the instruction is the configuration data instruction. If the configuration data decoder 19 recognizes that the instruction is the configuration data instruction having the operation code OPCA, the configuration data decoder 19 supplies the memory address MAD which is had in its field to the address generating unit 41. Subsequently, if the configuration data decoder 19 recognizes that the instruction is the configuration data instruction having the operation code OPCB, the configuration data decoder 19 supplies the configuration data number DN which is had in its field to the address generating unit 41.

The address generating unit 41 generates a memory address AD to be supplied to the configuration data memory 18 per cycle based on information of the first memory address MAD of the region in which the configuration data of the DRC 12 is housed and information of the configuration data number DN. In other words, the address generating unit 41 generates memory addresses AD of the number of the configuration data DN by using the memory address MAD as an initial value and sequentially increasing the value by a certain value per cycle and outputs the memory addresses AD. Then, the configuration data decoder 19 outputs the memory addresses AD sequentially generated by the address generating unit 41 and a read enable signal EN to the configuration data memory 18 and performs a read request.

Thereby, the configuration data of the DRC 12 housed in the plural memory addresses in the configuration data memory 18 is read from the configuration data memory 18 by two configuration data instructions, and housed in the configuration data buffer 14 of the DRC 12. Therefore, the configuration data housed in the plural memory addresses can be read by the two configuration data instructions, by not using configuration data instructions designating the memory addresses respectively, so that increase of the memory capacity necessary for storage of the instruction (program) can be further suppressed.

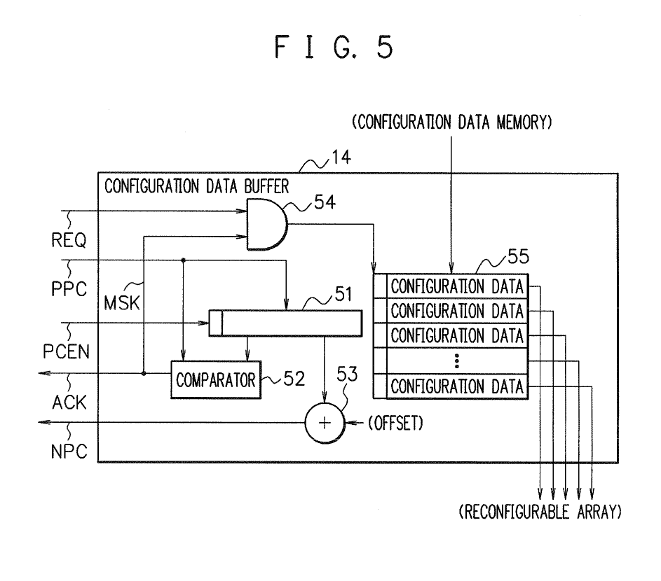

FIG. 5 is a diagram illustrating a configuration example of the configuration data buffer 14 in the present embodiment.

In FIG. 5, a reference number 51 denotes a register, a reference number 52 denotes a comparator, a reference number 53 denotes an adder, a reference number 54 denotes a logical product operation circuit (AND circuit), and a reference number 55 denotes a buffer.

The register 51 is a register for housing a program counter value PPC supplied from the processor 11. The register 51 retrieves and houses the program counter value PPC supplied from the processor 11 when an enable signal PCEN from the processor 11 is outputted. The enable signal PCEN is a signal notifying a timing for housing the supplied program counter value PPC into the register 51. The enable signal PCEN is outputted in accordance with supply of a program counter value where configuration data is designated by a plurality of configuration data instructions, that is, a program counter value of a first configuration data instruction in the plural configuration data instructions in a state where the plural configuration data instructions exist. Generation of the enable signal PCEN by the processor 11 is possible by providing a configuration data instruction indicating being a head of a configuration data instruction column.

The comparator 52 compares the program counter value held in the register 51 and the program counter value PPC supplied from the processor 11. If the two program counter values coincide with each other as a result of comparison, the comparator 52 outputs an acknowledge signal ACK to the outside and outputs a mask signal MSK to the AND circuit 54 (converts “1” to “0”).

If the two program counter values coincide with each other as a result of comparison in the comparator 52, the adder 53 adds an offset value to the program counter value held in the register 51, and outputs as a next program counter value NPC. Here, the offset value is a difference between a program counter value of a first configuration data instruction and a program counter value of a last configuration data instruction in the plural configuration data instructions, that is, the instruction number of the plural configuration data instructions.

To the AND circuit 54 is inputted a request signal REQ supplied from the processor 11 and the mask signal MSK outputted from the comparator 52, and the AND circuit 54 outputs its computation result to the buffer 55 as an enable signal. The enable signal outputted from the AND circuit 54 is a signal indicating whether or not to take the configuration data of the DRC 12 outputted from the configuration data memory 18 into the buffer 55. Further, the request signal REQ is a signal indicating that the configuration data of the DRC 12 is supplied from the configuration data memory 18. The buffer 55 houses and holds the configuration data of the DRC 12 supplied from the configuration data memory 18 in correspondence with the enable signal outputted from the AND circuit 54.

If the configuration data instruction is fetched, to the configuration data buffer 14, the configuration data of the DRC 12 is supplied from the configuration data memory 18 and the request signal REQ indicating that the configuration data is supplied is supplied from the processor 11. The processor 11 is capable of outputting a request signal REQ in correspondence with the configuration data instruction and outputting a program counter value of the configuration data instruction. For example, if configuration data is designated by a plurality of configuration data instructions, that is, if there is a plurality of configuration data instructions, the configuration data of the DRC 12 is held in the buffer 55 and the program counter value of the first configuration data instruction is held in the register 51. Next, if the same configuration data is supplied, the configuration data buffer 14 notifies the processor 11 that the configuration data already exists and, obtaining a program counter value of a next instruction of the configuration data instruction, notifies the processor 11 thereof by signals ACK, NPC. Whether or not the same configuration data is supplied is judged by comparing the program counter value held in the register 51 and the program counter value PPC supplied from the processor 11 by the comparator 52, and if the values coincide with each other it is determined that the same configuration data is supplied. Thereby, if the same configuration data is supplied, it is not necessary to perform an operation to house the configuration data from the configuration data memory 18 into the configuration data buffer 14 from the second time and after, and it is possible to perform the processings of the second time and after at a high speed.

Next, an operation of the data processing system in the first embodiment is explained. It is noted that if an instruction supplied to the processor 11 is not a configuration data instruction but an ordinary instruction, the processor 11 performs a processing corresponding to that instruction. Hereinafter, a case that the instruction supplied to the processor 11 is the configuration data instruction is explained.

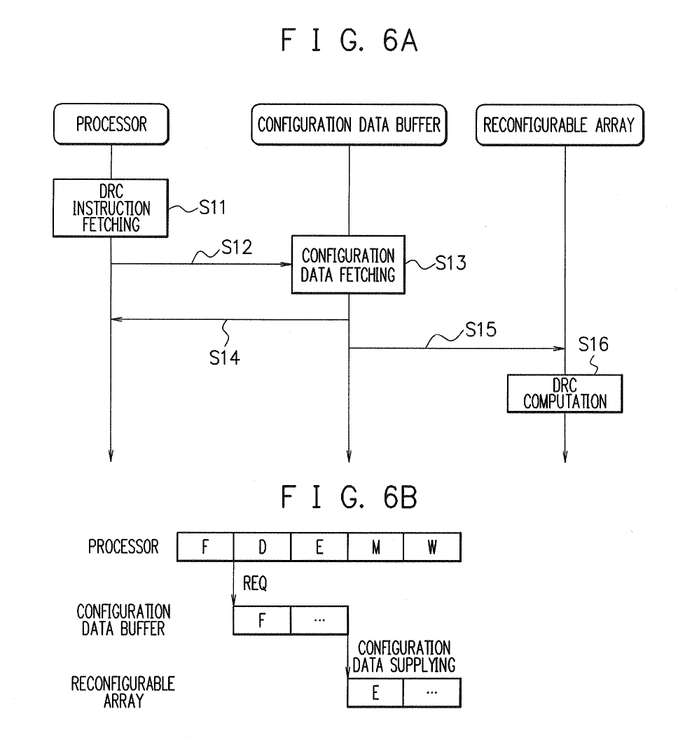

FIG. 6A is a diagram illustrating a DRC execution sequence of the data processing system in the first embodiment.

The processor 11 fetches a configuration data instruction having a memory address for reading configuration data as a field (S11), and outputs a request signal REQ to the configuration data buffer 14, the request signal REQ indicating that the configuration data is supplied (S12). Further, at the same timing as a timing at which the configuration data instruction is fetched, the configuration data decoder 19 decodes an operation code of the instruction and recognizes that the instruction is the configuration data instruction, and performs a read request to the configuration data memory 18. Thereby, the configuration data addressed by a memory address included in the configuration data instruction is read from the configuration data memory 18 and supplied to the configuration data buffer 14.

Next, the configuration data buffer 14 of the DRC 12, receiving the request signal REQ from the processor 11, houses the configuration data supplied from the configuration data memory 18 in the configuration data buffer 14 (S13). Then, when housing of the configuration data is completed, the configuration data buffer 14 outputs an acknowledge signal ACK indicating completion of housing of the configuration data to the processor 11 (S14).

Subsequently, the configuration data buffer 14 supplies the housed configuration data to the reconfigurable array 13 (S15). Thereby, a circuit configuration of the reconfigurable array 13 is altered. The reconfigurable array 13 performs a processing (DRC computation) in the altered circuit configuration (S16).

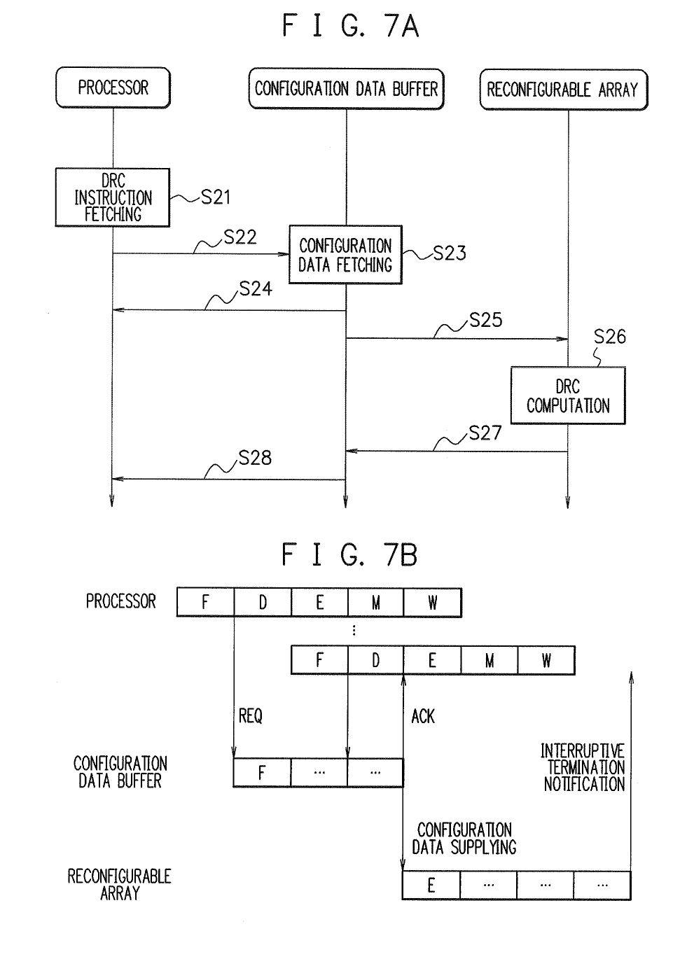

FIG. 7A is a diagram illustrating another example of a DRC execution sequence of the data processing system in the first embodiment. In FIG. 7A, there is illustrated the example of a case that data processing contents corresponding to configuration data are performed using one cycle or more. Operations of S21 to S26 in the execution sequence illustrated in FIG. 7A are similar to operations of S11 to S16 in the execution sequence illustrated in FIG. 6A.

The reconfigurable array 13 performs a processing (DRC computation) in an altered circuit configuration (S26), and when the processing terminates, notifies the configuration data buffer 14 of termination (S27). The configuration data buffer 14, when receiving a termination notification from the reconfigurable array 13, interruptively notifies the processor 11 of termination (S28).

Here, in FIG. 6B and FIG. 7B there are illustrated relationships among timings of respective stages related to processing execution in the processor 11, the configuration data buffer 14, and the reconfigurable array 13. In FIG. 6B and FIG. 7B, “F” denotes fetch process, “D” denotes decode process, “E” denotes execute process, “M” denotes memory access process, and “W” denotes write back process.

According to the first embodiment, when the instruction is fetched by the processor 11, the configuration data decoder identifies whether or not the instruction is the configuration data instruction having address information for reading configuration data housed in the configuration data memory 18 as the field. As a result, if the instruction is the configuration data instruction, based on the address information included in the configuration data instruction, the configuration data is read from the configuration data memory 18 and supplied to the configuration data buffer 14 of the DRC 12 and housed therein. Thereby, at the timing the same as the timing at which the configuration data instruction is fetched by the processor 11, the configuration data housed in the configuration data memory 18 is supplied to the DRC 12, so that the configuration data can be supplied at a high speed.

Further, it suffices if the address information for reading the configuration data, not the configuration data itself, is had in the configuration data instruction. In other words, even if software has a plurality of the same contents to be processed in the DRC 12, it suffices if only an address in which the configuration data is housed is designated and it is not necessary to have a plurality of the same configuration data. Therefore, it is possible to suppress increase of the memory capacity necessary for storage of the instruction (program). Further, since the configuration data is not included in the instruction, the instruction cache 16 is not required to house the configuration data, so that it becomes possible to use the instruction cache 16 effectively.

### Second Embodiment

Next, a second embodiment is explained.

In the above-described first embodiment, input data to be used for the data processing in the DRC 12 and output data as the processing result are given and received between the DRC 12 and the external memory 15 via the data cache 17. In the second embodiment explained below, input data to be used for a data processing in the DRC 12 and output data as a processing result are given and received directly between a processor 11 and the DRC 12.

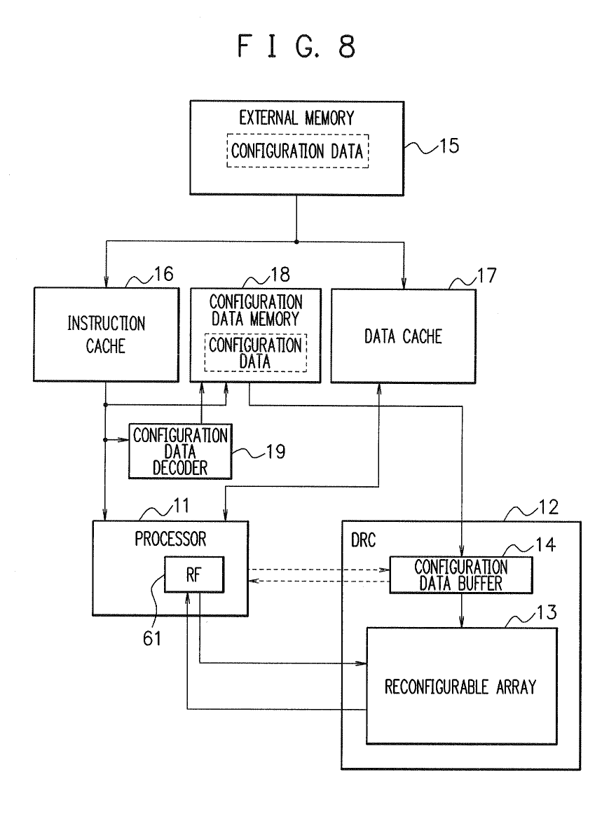

FIG. 8 is a block diagram illustrating a configuration example of a data processing system in the second embodiment. In FIG. 8, a component having the same function as that of the component illustrated in FIG. 1 is given the same reference number and redundant explanation is omitted.

In FIG. 8, the processor 11 has a register 61. The register 61 is connected to a reconfigurable array 13 in a manner to be able to give and receive data, and houses data for a data processing to be supplied to the reconfigurable array 13 and a result of the data processing by the reconfigurable array 13. The reconfigurable array 13 receives supply of the data housed in the register 61 from the processor 11 and performs a data processing, and supplies the processing result to the register 61.

Therefore, in the data processing system in the second embodiment, reading of data from an external memory 15 and writing of data into the external memory 15 which are related to the data processing are performed by the processor 11. Further, in the data processing system in the second embodiment, the reconfigurable array 13 performs neither reading nor writing of data from/to the external memory 15, and thus the address generating sequencer 38 in the configuration illustrated in FIG. 2 is unnecessary.

Next, an operation of the data processing system in the second embodiment is explained. It is noted that if an instruction supplied to a processor 11 is not a configuration data instruction but an ordinary instruction, the processor 11 performs a processing corresponding to that instruction. Hereinafter, a case that the instruction supplied to the processor 11 is a configuration data instruction is explained.

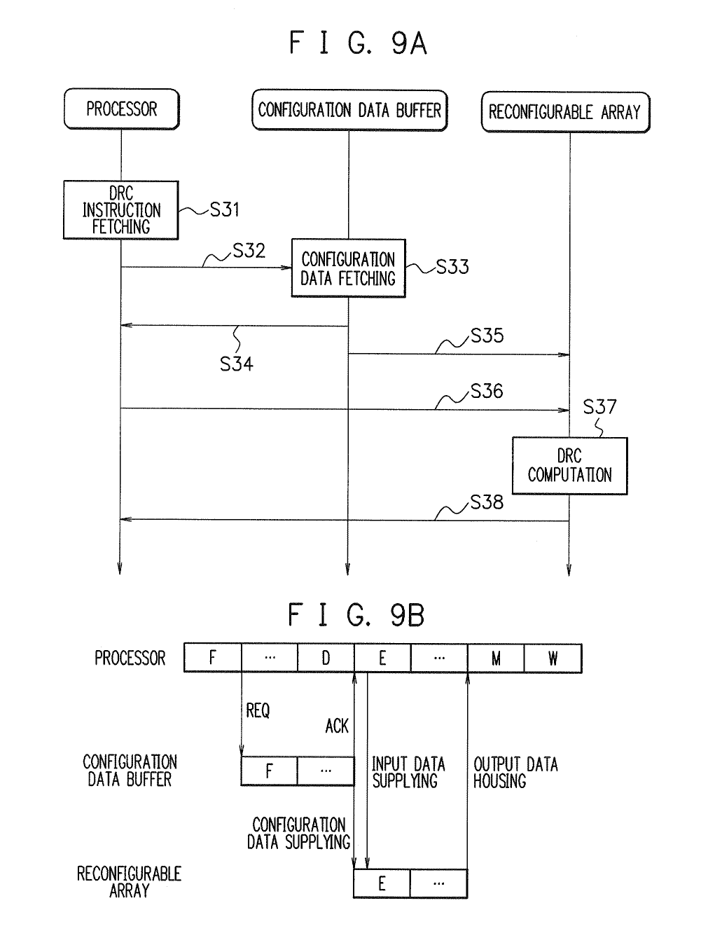

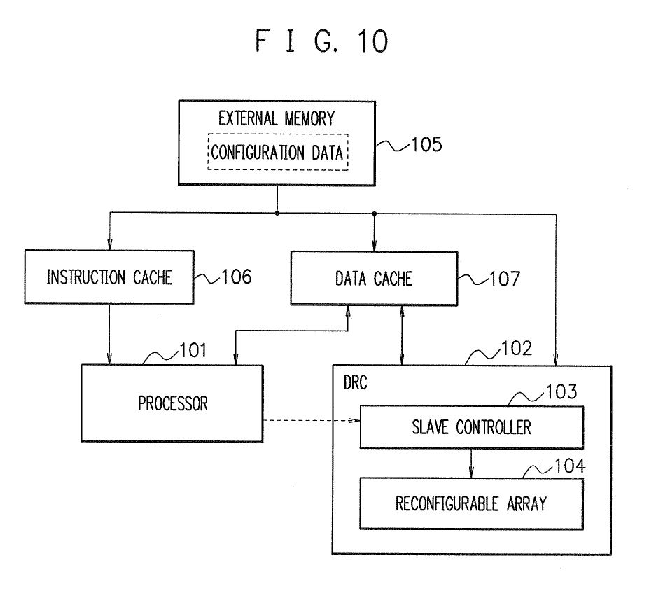

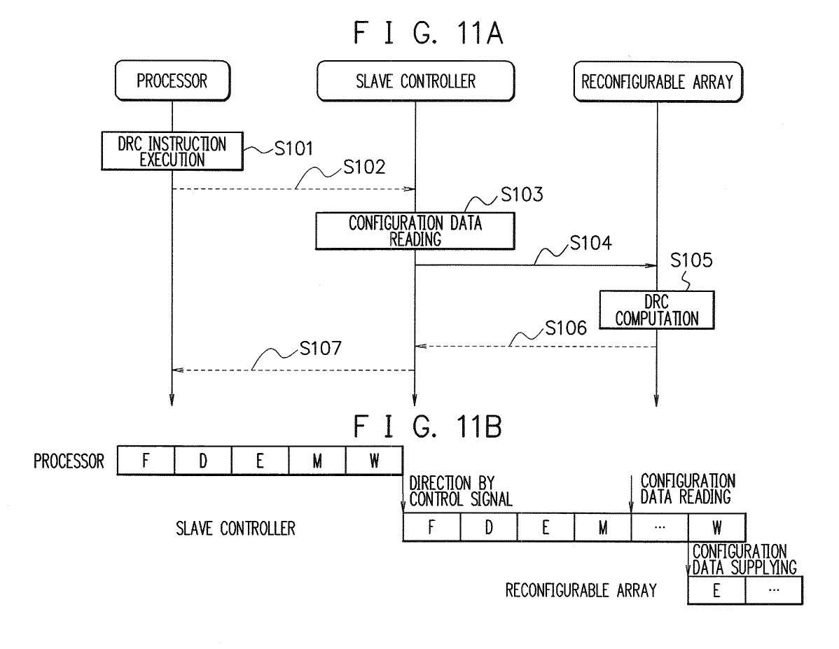

FIG. 9A is a diagram illustrating an example of a DRC execution sequence of the data processing system in the second embodiment.

The processor 11 fetches a configuration data instruction (S31) and outputs a request signal REQ to a configuration data buffer 14, the request signal REQ indicating that the configuration data is supplied (S32). Further, at the same timing as a timing at which the configuration data instruction is fetched, it is recognized that the instruction is the configuration data instruction by a configuration data decoder 19, and a read request is performed to a configuration data memory 18. Thereby, the configuration data addressed by a memory address included in the configuration data instruction is read from the configuration data memory 18 and supplied to the configuration data buffer 14.

Next, the configuration data buffer 14 of the DRC 12, when receiving the request signal REQ from the processor 11, houses the configuration data supplied from the configuration data memory 18 in the configuration data buffer 14 (S33). Then, when housing of the configuration data is completed, the configuration data buffer 14 outputs an acknowledge signal ACK indicating completion of housing of the configuration data to the processor 11 (S34).

Subsequently, the configuration data buffer 14 supplies the housed configuration data to the reconfigurable array 13 (S35). Thereby, a circuit configuration of the reconfigurable array 13 is altered. Next, the processor 11 outputs a data enable signal to the reconfigurable array 13 and supplies the data housed in the register 61 as input data (S36). The reconfigurable array 13 performs a processing (DRC computation) in the altered circuit configuration by using the data supplied from the processor 11 as the input data (S37).

When the processing (DRC computation) in the altered circuit configuration terminates, the reconfigurable array 13 outputs a data enable signal to the processor 11 and supplies data obtained as a processing result as output data (S38). The processor 11, when receiving the output data, houses the data supplied from the reconfigurable array 13 as the output data into the register 61.

In FIG. 9B there is illustrated a relationship among timings of respective stages related to processing execution in the processor 11, the configuration data buffer 14, and the reconfigurable array 13. In FIG. 9B, “F” denotes fetch process, “D” denotes decode process, “E” denotes execute process, “M” denotes memory access process, and “W” denotes write back process.

According to the second embodiment, a similar effect to that of the first embodiment can be obtained. Further, by using the register 61, it becomes possible that data is given and received between the processor 11 and the reconfigurable array 13 and processed, and a complicated data processing becomes possible to be performed. It is noted that though in the second embodiment the register 61 is provided inside the processor 11 the register 61 may be provided outside the processor 11 as long as the register 61 is connected to each of the processor 11 and the reconfigurable array 13 in a manner to be able to give and receive data.

In the disclosed data processing system, when an instruction is a configuration data instruction, configuration data is read from a configuration data memory and supplied to a second processing unit at a timing the same as a timing at which the instruction is fetched, and thus an effect is given that the configuration data can be supplied at a high speed. Further, since the configuration data instruction is not the configuration data itself and has only to have address information for reading the configuration data, an effect is given that increase of a memory capacity necessary for storage of the instruction can be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data processing system comprising:
a first processing unit performing a processing in correspondence with a fetched instruction;
a second processing unit being a processing unit different from the first processing unit and capable of dynamically reconfiguring a circuit configuration in correspondence with configuration data;
a configuration data memory in which the configuration data is housed; and
a decoding unit identifying, when the first processing unit fetches the instruction, whether or not the instruction is a configuration data instruction,
wherein, when the instruction fetched by the first processing unit is the configuration data instruction, the decoding unit reads the configuration data from the configuration data memory and supplies to the second processing unit, based on address information included in the configuration data instruction.

2. The data processing system according to claim 1, comprising:
a buffer unit housing the configuration data read from the configuration data memory,
wherein the second processing unit reconfigures a circuit configuration in accordance with the configuration data housed in the buffer.

3. The data processing system according to claim 1, comprising:
a register connected to the second processing unit and capable of receiving data from the first processing unit and giving data to the first processing unit.

4. The data processing system according to claim 1,
wherein the decoding unit comprises an address generating unit generating a memory address for reading the configuration data from the configuration data memory based on the address information.

5. The data processing system according to claim 4,
wherein the address information includes a memory address indicating a head of a region in which the configuration data to be read is housed and a data amount of the configuration data to be read, and
wherein the address generating unit generates the memory address for reading the configuration data from the configuration data memory, based on the memory address and the data amount of the address information.

6. The data processing system according to claim 1,
wherein the address information is a memory address in which the configuration data to be read is housed, and
wherein the address information included in the configuration data instruction is supplied to the configuration data memory, and when the instruction is a configuration data instruction, the decoding unit performs an output request to the configuration data memory.

7. The data processing system according to claim 2,
wherein, when the instruction the first processing unit fetches coincides with the configuration data instruction to read the configuration data housed in the buffer unit from the configuration data memory in terms of a program counter value, the buffer unit renews a program counter value by adding a value corresponding to the configuration data housed in the buffer unit.

8. The data processing system according to claim 2,
wherein, when the instruction the first processing unit fetches is the configuration data instruction by which the configuration data the same as the configuration data housed in the buffer unit is read from the configuration data memory, the configuration data instruction corresponding to the configuration data housed in the buffer unit is skipped.

9. The data processing system according to claim 1,
wherein the configuration data housed in the configuration data memory is a copy of the configuration data an external memory different from the configuration data memory stores.

10. The data processing system according to claim 1,
wherein the second processing unit comprises a plurality of registers and a multifunctional block having arbitrary functions.

11. The data processing system according to claim 10,
wherein the configuration data includes information related to function control of the multifunctional block, and information related to a connection between the multifunctional block and the register.

12. The data processing system according to claim 1,
wherein the second processing unit is capable of executing data processing contents corresponding to the configuration data using a period of a plurality of cycles and capable of notifying the first processing unit of completion of execution.

13. A control method for a data processing system comprising a first processing unit performing a processing in correspondence with a fetched instruction and a second processing unit capable of dynamically reconfiguring a circuit configuration in correspondence with configuration data, the method comprising:
identifying whether or not the instruction is a configuration data instruction, when the first processing unit fetches the instruction; and
reading the configuration data from a configuration data memory in which the configuration data is housed and supplying the configuration data to the second processing unit, when the instructions is identified to be the configuration data instruction, based on address information included in the configuration data instruction.

14. The control method for the data processing system according to claim 13, the method comprising:
generating a memory address for reading the configuration data from the configuration data memory, based on the address information,
wherein the configuration data is read from the configuration data memory by using the memory address generated.
